(19) United States
(12) Patent Application Publication
(10) Pub. No.: US 2017/0206540 A1
(43) Pub. Date: Jul. 20, 2017

(54) ONLINE SURVEY PROBLEM REPORTING SYSTEMS AND METHODS

(71) Applicant: SURVEYMONKEY INC., Palo Alto, CA (US)

(72) Inventors: GAURAV OBEROI, Seattle, WA (US); CHARLES GROOM, Seattle, WA (US)

(21) Appl. No.: 15/000,692

(22) Filed: Jan. 19, 2016

(51) Int. Cl. G06Q 30/02; H04L 12/26

(52) U.S. Cl. CPC G06Q 30/0203; H04L 43/16

(57) ABSTRACT

A system can include a display device and a processor. The processor can cause the display device to visually present questions to an online survey taker, receive from the online survey taker an indication of a problem with at least one of the questions, and generate a report based on at least the indication received from the online survey taker.

### TECHNICAL FIELD

The technical field pertains generally to systems and methods for administering online surveys and, more particularly, to allowing online survey takers to provide feedback concerning one or more online survey questions with which they perceive a problem.

### BACKGROUND

Online surveys have become increasingly valuable to individuals, companies, and virtually all types of organizations by enabling such entities to quickly and efficiently obtain various types of information from any number of target populations. Such information may include customer preferences, feedback on products and/or services, and customer service-related information. Companies may incorporate such information in making various business and/or strategic or otherwise tactical decisions, for example. Also, the continued prevalence of mobile electronic devices, such as smartphones and tablet devices, in today's society provides individuals and groups with even greater access to virtually every type of target population for electronic surveys and other information-gathering mechanisms. Indeed, millions of people use the Internet and/or other networks on a regular—often daily—basis, both at home and at the workplace. Accordingly, there remains a need for further improvements in facilitating the administering and management of online surveys, including the reporting of perceived problems with particular online survey questions.

### BRIEF DESCRIPTION OF THE DRAWINGS

FIG. 1 illustrates an example of a networked system in accordance with certain embodiments of the disclosed technology.

FIG. 2 illustrates an example of an electronic device in which certain aspects of various embodiments of the disclosed technology may be implemented.

FIG. 3 illustrates an example of a user interface configured to visually present to an online survey taker one or more introductory questions and a problem reporting mechanism for the online survey in accordance with certain embodiments of the disclosed technology.

FIG. 4 illustrates an example of a reported problem detail user interface in accordance with certain embodiments of the disclosed technology.

FIG. 5 illustrates an example of a user interface configured to visually present to an online survey taker one or more introductory questions and a problem detail sub-interface for the online survey in accordance with certain embodiments of the disclosed technology.

FIG. 6 illustrates an example of a user interface configured to visually present to a user one or more online survey questions and a problem reporting mechanism in accordance with certain embodiments of the disclosed technology.

FIG. 7 illustrates an example of a reported problem detail user interface in accordance with certain embodiments of the disclosed technology.

FIG. 8 illustrates an example of a user interface configured to visually present to a user one or more online survey questions and a problem detail sub-interface in accordance with certain embodiments of the disclosed technology.

FIG. 9 illustrates an example of a computer-controlled method in accordance with certain embodiments of the disclosed technology.

FIG. 10 illustrates an example of a computer-controlled method in accordance with certain embodiments of the disclosed technology.

### DETAILED DESCRIPTION

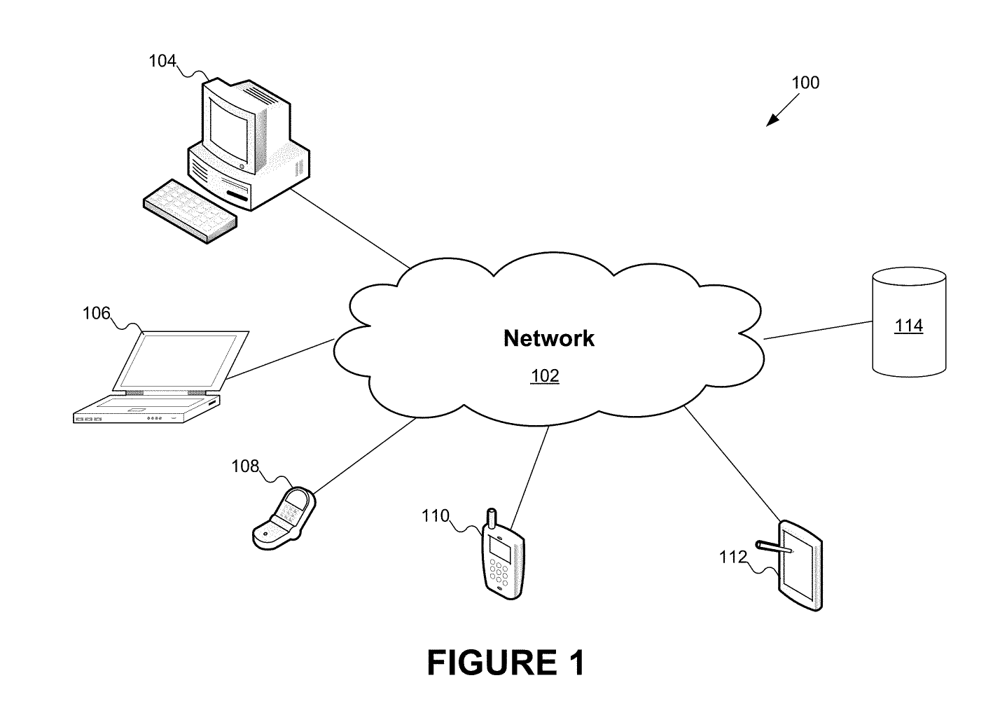

FIG. 1 illustrates an example of a networked system 100 in accordance with certain embodiments of the disclosed technology. In the example, the system 100 includes a network 102 such as the Internet, an intranet, a home network, a public network, or any other network suitable for implementing embodiments of the disclosed technology. In the example, personal computers 104 and 106 may connect to the network 102 to communicate with each other or with other devices connected to the network.

The system 100 also includes three mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. In the example, a storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

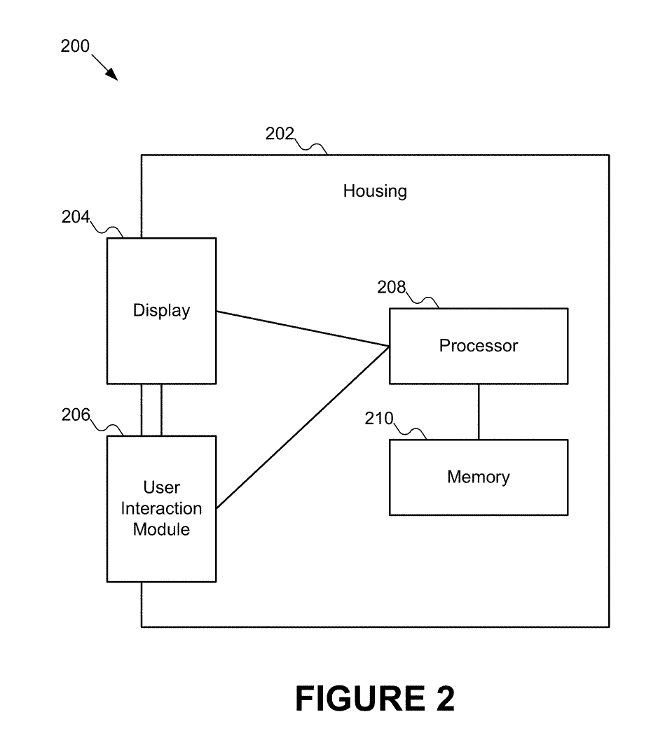

FIG. 2 illustrates an example of an electronic device 200, such as the devices 104-112 of the networked system 100 of FIG. 1, in which certain aspects of various embodiments of the disclosed technology may be implemented. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaking, or any combination thereof, or a virtual device, such as a virtual keypad implemented within a touchscreen. The processor 208 may perform any of a number of various operations. The memory 210 may store information used by or resulting from processing performed by the processor 208.

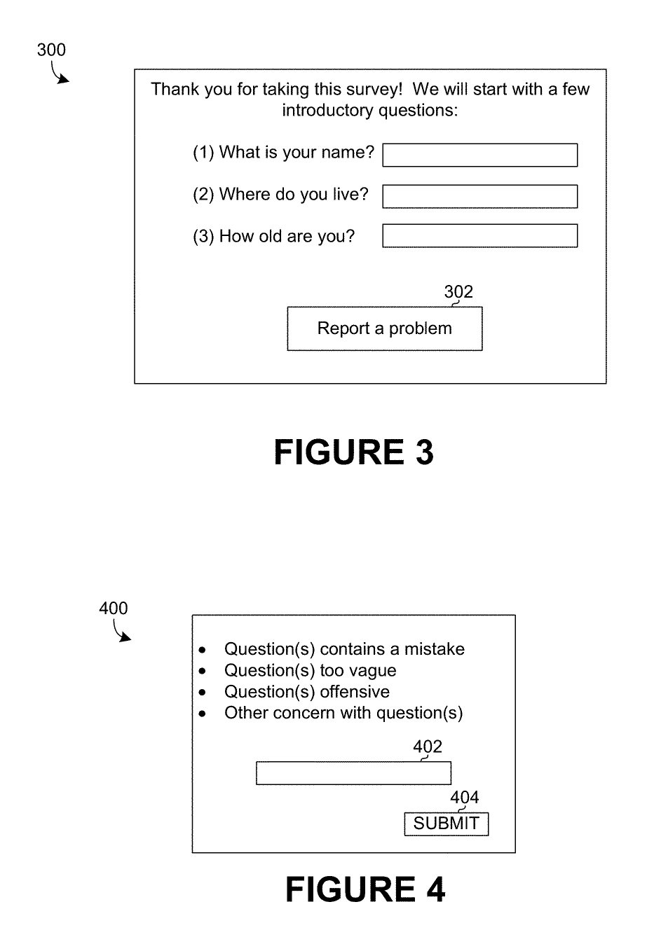

FIG. 3 illustrates an example of a user interface 300 configured to visually present to an online survey taker one or more introductory questions and a problem reporting mechanism 302 for the online survey in accordance with certain embodiments of the disclosed technology. In the example, if the online survey taker perceives a problem or issue with one or more of the introductory questions presented to him or her, he or she may engage the problem reporting mechanism 302. For example, in implementations where the problem reporting mechanism 302 is a virtual button, the online survey taker may click on the virtual button (e.g., by way of a mouse or, in the case of touch-capable devices, by way of touching by the user's finger, a stylus, or other suitable device).

In the example, an online survey taker may find either or both of the first and second questions too vague or unclear. For example, the user may wish to know whether the first question is asking for first name and last name, first name and last name and middle initial, full legal name, username, etc. Alternatively or in addition thereto, the user may wish to know whether the second question is asking for a geographic location, such as city, state, country, etc., a type of residence, such as in a house, apartment, etc., or a type of area, such as urban, suburban, country, etc.

In the example, should the online survey taker perceive a problem with either or both of the first and second questions, the user may decide to engage the problem reporting mechanism 302. User engagement with the problem reporting mechanism 302 may provoke the launching of a reported problem detail user interface such as that illustrated by FIG. 4, discussed below.

FIG. 4 illustrates an example of a reported problem detail user interface 400 in accordance with certain embodiments of the disclosed technology. In the example, the reported problem detail user interface 400 may be presented to the online survey taker responsive to the survey taker engaging the problem reporting mechanism 302 of FIG. 3. The reported problem detail user interface 400 may be configured to allow the online survey taker to provide information specific to the perceived problem or issue with the one or more introductory questions presented to him or her by the user interface 300 of FIG. 3.

In the example, the reported problem detail user interface 400 provides multiple-choice options that the user may select: the question(s) contains a mistake, the question(s) is too vague, or the question(s) is offensive. The user may also provide information pertaining to a different concern regarding the question(s), e.g., by way of a free-form user input mechanism 402 which may include a text box within which the user may enter the information, for example.

The interface 400 may optionally include a Submit button 404 that the user may engage to signal that he or she has finished providing the problem detail. Alternatively, the interface 400 may be configured to assume the user is finished providing the detail once one of the provided selections is chosen or responsive to the user hitting the enter/return key on the keyboard after entering text in the input mechanism 402.

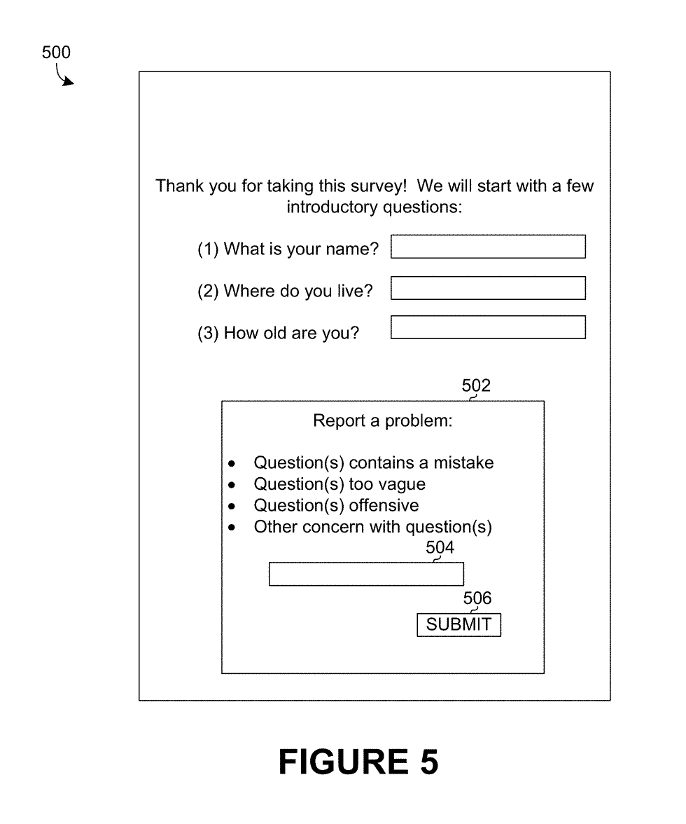

FIG. 5 illustrates an example of a user interface 500 configured to visually present introductory questions and a problem detail sub-interface 502 for an online survey in accordance with certain embodiments of the disclosed technology. The user interface 500 illustrated by FIG. 5 has features similar to both the user interface 300 illustrated by FIG. 3 and the user interface 400 illustrated by FIG. 4. However, unlike the user interfaces 300 and 400 of FIGS. 3 and 4, respectively, the user interface 500 of FIG. 5 provides a combination of functionalities in a single visual presentation.

In the example, if an online survey taker finds either or both of the first and second questions too vague or unclear, the user may take advantage of the problem detail sub-interface 502 to report the perceived problem(s) and also provide details about the problem(s). For example, the user may interact with the sub-interface 502 to indicate whether a certain question: contains a mistake, is too vague, or is offensive. The user may also provide information pertaining to a different concern regarding the question(s), e.g., by way of a free-form user input mechanism 504 which may include a text box within which the user may enter the information, for example.

In the example, the user may engage an optional Submit button 506 to signal that he or she has finished providing the problem detail. Alternatively, the interface 502 may be configured to assume the user is finished providing the detail once one of the provided selections is chosen or responsive to the user hitting the enter/return key on the keyboard after entering text in the input mechanism 504.

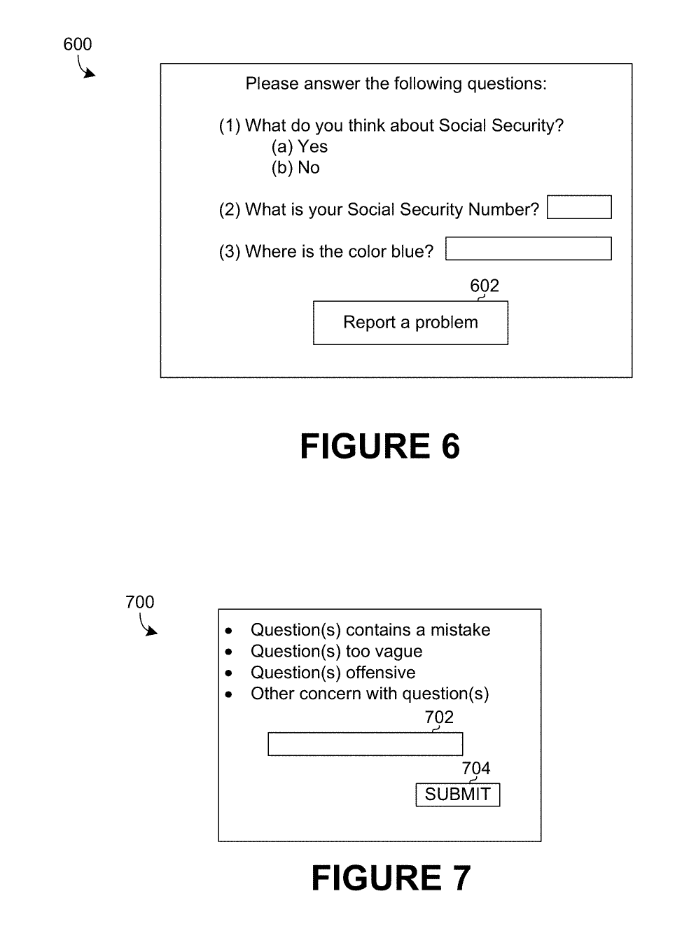

FIG. 6 illustrates an example of a user interface 600 configured to visually present online survey questions and a problem reporting mechanism 602 in accordance with certain embodiments of the disclosed technology. In the example, if the online survey taker perceives a problem or issue with one or more of the online survey questions presented to him or her, he or she may engage the problem reporting mechanism 602. For example, in implementations where the problem reporting mechanism 602 is a virtual button, the online survey taker may click on the virtual button (e.g., by way of a mouse or, in the case of touch-capable devices, by way of touching by the user's finger, a stylus, or other suitable device).

In the example, an online survey taker may believe that either or both of the first and third questions contain a mistake. For example, despite the answer choices being “yes” or “no,” the user may believe that the first question is not a yes-or-no question. Alternatively or in addition thereto, the user may find the third question to be nonsensical. In other situations, a user may find the second question offensive because the user may believe sensitive information such as a Social Security Number to be too personal to be solicited from an online survey.

In the example, should the online survey taker perceive a problem with any or all of the first, second, and third online survey questions, the user may decide to engage the problem reporting mechanism 602. User engagement with the problem reporting mechanism 602 may provoke the launching of a reported problem detail user interface such as that illustrated by FIG. 7, discussed below.

FIG. 7 illustrates an example of a reported problem detail user interface 700 in accordance with certain embodiments of the disclosed technology. In the example, the reported problem detail user interface 700 provides multiple-choice options that the user may select: the question(s) contains a mistake, the question(s) is too vague, or the question(s) is offensive. The user may also provide information pertaining to a different concern regarding the question(s), e.g., by way of a free-form user input mechanism 702 which may include a text box within which the user may enter the information, for example.

The interface 700 may optionally include a Submit button 704 that the user may engage to signal that he or she has finished providing the problem detail. Alternatively, the interface 700 may be configured to assume the user is finished providing the detail once one of the provided selections is chosen or responsive to the user hitting the enter/return key on the keyboard after entering text in the input mechanism 702.

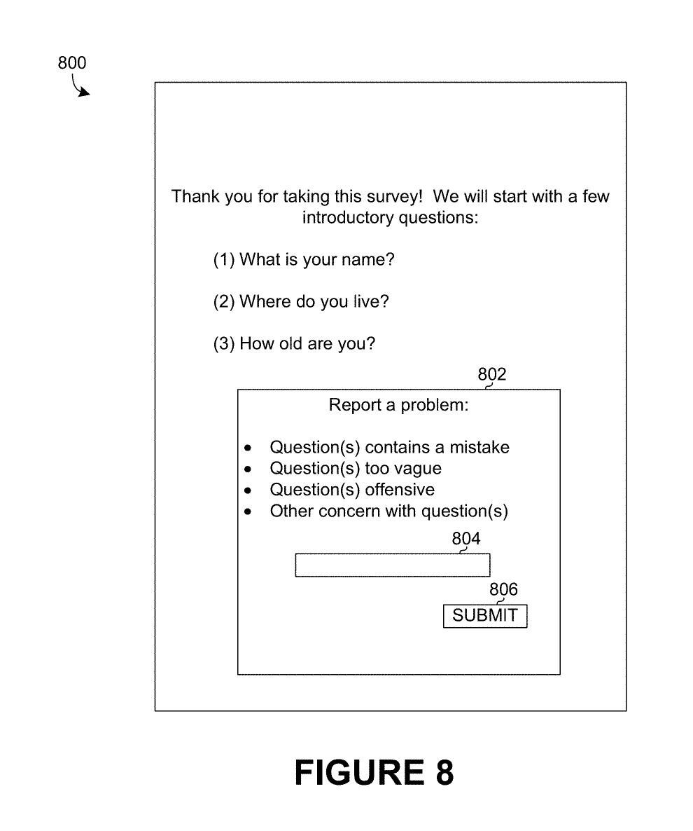

FIG. 8 illustrates an example of a user interface 800 configured to visually present online survey questions and a problem detail sub-interface 802 in accordance with certain embodiments of the disclosed technology. The user interface 800 illustrated by FIG. 8 has features similar to both the user interface 600 illustrated by FIG. 6 and the user interface 700 illustrated by FIG. 7. However, unlike the user interfaces 600 and 700 of FIGS. 6 and 7, respectively, the user interface 800 of FIG. 8 provides a combination of functionalities in a single visual presentation.

In the example, if an online survey taker perceives a problem with any or all of the first, second, and third questions, the user may take advantage of the problem detail sub-interface 802 to report the perceived problem(s) and also provide details about the problem(s). For example, the user may interact with the sub-interface 802 to indicate whether a certain question: contains a mistake, is too vague, or is offensive. The user may also provide information pertaining to a different concern regarding the question(s), e.g., by way of a free-form user input mechanism 804 which may include a text box within which the user may enter the information, for example.

Once finished providing detail, the user may engage an optional Submit button 806 to signal that he or she has finished providing the problem detail. Alternatively, the interface 802 may be configured to assume the user is finished providing the detail once one of the provided selections is chosen or responsive to the user hitting the enter/return key on the keyboard after entering text in the input mechanism 804.

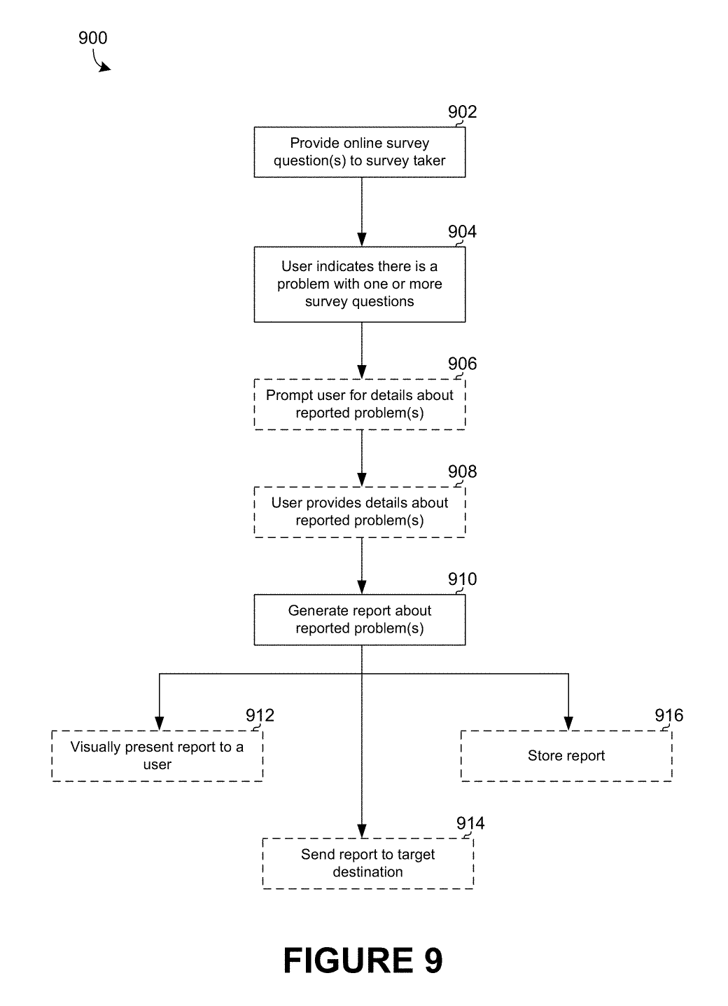

FIG. 9 illustrates an example of a computer-controlled method 900 in accordance with certain embodiments of the disclosed technology.

At 902, one or more questions from an online survey are visually presented to an online survey taker, such as the introductory questions presented by the user interfaces 300 and 500 of FIGS. 3 and 5, respectively, or the online survey questions presented by the user interfaces 600 and 800 of FIGS. 6 and 8, respectively.

At 904, the online survey taker indicates that he or she perceives a problem with one or more of the presented questions. The user may provide such indication by interacting with a user interface such as any of the illustrated user interfaces described above.

At 906, the online survey taker may optionally be prompted for more details about the perceived problem(s), e.g., by way of a user interface such as the reported problem detail user interfaces 400 and 700 of FIGS. 4 and 7, respectively. The user may then interact with such user interface to provide the detail, as shown at 908.

In certain embodiments, the system may obtain additional information that is not necessarily reported by—or even able to be reported by—the user. For example, the system may identify at which point/location of the online survey the user was when he or she dropped off from the survey. Alternatively or in addition thereto, the system may identify how long the user had been participating with the survey before dropping off. Alternatively or in addition thereto, the system may identify which type of device (e.g., tablet or smart phone) the user was using to take the online survey.

At 910, a report is generated based on the reported problem(s). In certain embodiments, the report may include an accumulation of information pertaining to each question from all of the online surveys taken by online survey takers. For example, the report may indicate how many online survey takers indicated that a certain question in an online survey was too vague and/or how many online survey takers indicated that a different question in the survey contained a mistake.

The report generated at 910 may optionally be visually presented to a user, as shown at 912, sent to a target destination, as shown at 914, and/or stored, e.g., by a memory device, as shown at 916.

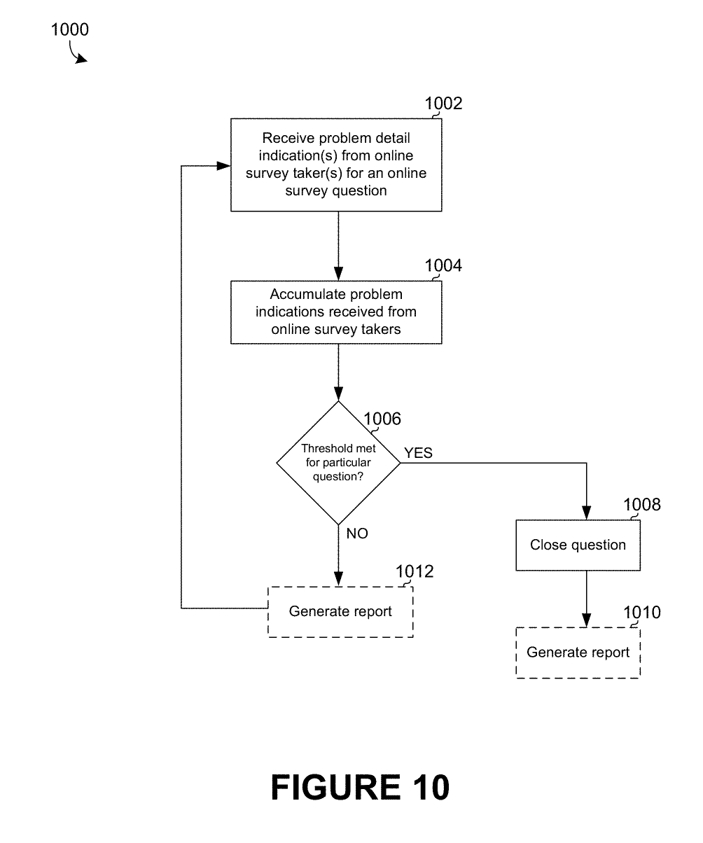

FIG. 10 illustrates an example of a computer-controlled method 1000 in accordance with certain embodiments of the disclosed technology.

At 1002, indications of a potential problem with a particular online survey question are received by at least one online survey taker, such as by way of any of the illustrated user interfaces described above, for example.

At 1004, the potential problem indications received from online survey takers at 1002 are accumulated. Such accumulation may be performed in real-time, at certain designated times (e.g., as a batch job). In certain implementations, the accumulation may be real-time at certain times (e.g., late at night and/or during weekends) and at designated interval and/or batch times at other times.

At 1006, a determination is made as to whether the received problem indications exceed a certain threshold for the particular question. The threshold may be determined by the creator of the online survey or by an administrator of the online survey, for example. In certain implementations, the threshold may be a raw total, e.g., a total number of problem indications received. In alternative implementations, the threshold may be a total number of designated indications, e.g., a total number of indications that the online survey question is vague or unclear, a total number of indications that the question is offensive, or a weighted total thereof (e.g., where indications that the problem is vague have double the weight of indications that the problem is offensive). In certain implementations, any freeform text entry may carry the same weight as a pre-provided selection, e.g., that the question is vague. Alternatively, a freeform text entry might not be included in the threshold determination but, instead, be provided separate from the non-freeform text entries.

Responsive to a determination that the threshold was met at 1006, the online survey question may be closed, as indicated at 1008. In such situation, the question may be immediately removed from the survey and, thus, no longer provided to online survey takers that take the survey. An optional report may be generated to provide information concerning the closed question, as indicated at 1010.

Responsive to a determination that the threshold was not met at 1006, the online survey may continue to operate and the processing at 1002 and 1004 may continue. At 1012, an optional report may be generated to provide information pertaining to the accumulated problem indications, e.g., in real-time or at certain designated times.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
a display device; and
a processor operable to:
cause the display device to visually present a plurality of questions to at least one online survey taker;
receive from the at least one online survey taker an indication of a problem with at least one of the plurality of questions; and
generate a report based on the indication received from the at least one online survey taker.

2. The system of claim 1, further comprising a remote device configured to receive the indication of the problem from the processor.

3. The system of claim 2, wherein the remote device is configured to accumulate indications of at least the problem received from multiple online survey takers.

4. The system of claim 3, wherein the remote device is configured to determine whether a count of the accumulated indications exceeds a predefined threshold.

5. The system of claim 4, wherein the remote device is further configured to close the online survey question responsive to the threshold being met.

6. The system of claim 5, wherein the remote device is further configured to generate a report pertaining to the closed online survey question.

7. The system of claim 1, wherein the processor is further operable to request from the online survey taker problem details pertaining to the indication of the problem.

8. The system of claim 7, wherein the processor is further operable to cause the display device to visually present to the online survey taker a reported problem detail user interface.

9. The system of claim 8, wherein the reported problem detail user interface is operable to enable the online survey taker to provide an indication that the online survey question is too vague, contains a mistake, or is offensive.

10. The system of claim 8, wherein the reported problem detail user interface is operable to enable the online survey taker to provide a freeform text entry pertaining to the online survey question.

11. The system of claim 1, further comprising a storage device configured to store the generated report.

12. The system of claim 1, wherein the processor is further operable to cause the display device to visually present the generated report.

13. A computer-controlled method, comprising:
a display device visually presenting a plurality of questions to at least one online survey taker;
a processor receiving from the at least one online survey taker an indication of a problem with at least one of the plurality of questions; and
the processor generating a report based on the indication received from the at least one online survey taker.

14. The computer-controlled method of claim 13, further comprising a remote device receiving the indication of the problem from the processor.

15. The computer-controlled method of claim 14, further comprising the remote device accumulating indications of at least the problem received from multiple online survey takers.

16. The computer-controlled method of claim 15, further comprising the remote device determining whether a count of the accumulated indications exceeds a predefined threshold.

17. The computer-controlled method of claim 16, further comprising the remote device closing the online survey question responsive to the threshold being met.

18. The computer-controlled method of claim 17, further comprising the remote device generating a report pertaining to the closed online survey question.
